(19) United States
(12) Patent Application Publication
(10) Pub. No.: US 2025/0124171 A1
(43) Pub. Date: Apr. 17, 2025

(54) SECURE REAL TIME VOICE ANONYMIZATION AND RECOVERY

(71) Applicant: Intel Corporation, Santa Clara, CA (US)

(72) Inventors: Przemyslaw Maziewski, 80298 Gdansk Pomeranian (PL); Lukasz Pindor, Pruszcz Gdanski, Pomorskie, 83-000 (PL); Adam Kupryjanow, Gdansk (PL)

(73) Assignee: Intel Corporation, Santa Clara, CA (US)

(21) Appl. No.: 18/999,422

(22) Filed: Dec. 23, 2024

Related U.S. Application Data
(60) Provisional application No. 63/618,751, filed on Jan. 8, 2024.

(51) Int. Cl. G06F 21/62; G10L 15/02; G10L 21/007; G10L 25/30; H04L 9/40

(52) U.S. Cl. CPC G06F 21/6254; G10L 15/02; G10L 21/007; G10L 25/30; H04L 63/0421

(57) ABSTRACT

Voice anonymization systems and methods are provided. Voice anonymization is done on the speaker's computing device and can prevent voice theft. The voice anonymization systems and methods are lightweight and run efficiently in real time on a computing device, allowing for speaker anonymity without diminishing system performance during a teleconference or VoIP meeting. The anonymization system outputs a transformed speaker voice. The anonymization system can also generate a voice embedding that can be used to reconstruct the original speaker voice. The voice embedding can be encrypted and transmitted to another device. Sometimes, the voice embedding is not transmitted and the listener receives the anonymized voice. Systems and methods are provided for the detection of voice transformations in received audio. Thus, a listener can be informed whether the speaker voice output from the listener's computing device is the original speaker's voice or a transformed version of the original speaker voice.

### CROSS-REFERENCE TO RELATED APPLICATION

This application is related to and claims the benefit of priority under 35 U.S.C. § 119(e) to U.S. Provisional Application No. 63/618,751 titled “Secure Real Time Voice Anonymization and Recovery” filed on Jan. 8, 2024, which is hereby incorporated by reference in its entirety.

### TECHNICAL FIELD

This disclosure relates generally to voice anonymization, and in particular to secure real time voice anonymization and subsequent voice recovery.

### BACKGROUND

Biometric data, such as voice or facial images, can be stolen. Stolen data can be used for deepfakes or biometric attacks. Thus, there is a need for secure transmission of biometric data over wireless connections. Furthermore, many people prefer to protect their privacy during teleconferences and other online conversations. For example, users blur or alter their backgrounds, use avatars, or keep their video cameras turned off entirely. In general, there is a need for privacy and identity protection for online meetings and conferences.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a DNN system, in accordance with various embodiments.

FIG. 2 shows an example of a voice anonymization system, in accordance with various embodiments.

FIG. 3 is a diagram illustrating details of a voice anonymization module, in accordance with various embodiments.

FIGS. 4A-4B illustrate an example architecture for implementing a voice anonymization module, in accordance with various embodiments.

FIG. 5 illustrates a voice anonymization system including two computing devices, and a cloud, in accordance with various embodiments.

FIG. 6 is a diagram illustrating an example of a capture pipeline, in accordance with various embodiments.

FIG. 7 is a diagram illustrating an example of a render pipeline, in accordance with various embodiments.

FIG. 8 is a flowchart illustrating a method for voice anonymization, in accordance with various embodiments.

FIG. 9 is a block diagram of an example computing device, in accordance with various embodiments.

### DETAILED DESCRIPTION

### Overview

Systems and methods are provided to anonymize a speaker's voice before sending it over the Internet, and then recover the speaker's voice on the listener's computing device. The anonymization is done on the speaker's computing device and is intended to prevent voice theft online and on the Internet. Voice recovery is performed on the listener's computing device and allows the speaker's original voice to be securely restored. In general, systems and methods are provided to alter voice characteristics of a speakers voice to prevent potential voice “theft” while preserving the speaking style of the speaker as well as other unique aspects of the speaker's delivery. Thus, the speaker's voice may not be a completely unrecognizable voice, but sufficient voice characteristics are altered to prevent voice cloning. The voice anonymization systems and methods are lightweight and can run efficiently in real time on a computing device, allowing for speaker anonymity without diminishing system performance.

The systems and methods provided to anonymize a speaker voice output a transformed speaker voice and a voice embedding that can be used to reconstruct the original speaker voice. In particular, the systems and methods can include automatic extraction of the voice embedding, encryption of the voice embedding, and secure transmission of the voice embedding between the speaker's computing device and the listener's computing device. When the voice embedding is transmitted to the listener's computing device, the original speaker voice can be reconstructed at the listener's computing device. In some examples, the voice embedding is not transmitted and the listener only receives the transformed (anonymized) voice.

Systems and methods are provided for the detection of voice transformations on the receiving computing device, including detection of so-called deepfakes. Thus, a listener can be informed whether the speaker voice output from the listener's computing device is the original speaker's voice or a transformed version of the original speaker voice. Such a detector can become a built-in feature of a computing device that can be used in real time during any wireless communication, such as a VoIP call.

In general, techniques are provided herein for performing the operations described above in real time on each computing device. This can be referred to as processing at the edge. Performing the operations in real time on each computing device increases security since private data does not leave the speaker's computing device. In various examples, the systems and methods described herein can be used in different domains, for instance to anonymize and re-authenticate facial images and/or on teleconferencing devices such as PCs and other computing devices.

Current systems for voice anonymization are not performed in real time. Voice anonymization can be performed in a cloud-based web service that requires uploading the voice recording to the Internet. It is less secure because the original voice can be intercepted during upload or in the cloud. Another method is to use traditional DSP techniques with which to change the pitch of the voice, making the voice sound unnatural. Additionally, deepfake detectors are not part of typical audio stack on a computing device. Systems and methods that are implemented in higher software layers of the operating system or in the Internet cloud are vulnerable to potential voice theft. Moreover, systems and methods that are implemented in higher software layers of the operating system or in the Internet cloud are not an integral part of Voice over IP (VoIP) teleconferencing systems.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example DNN System

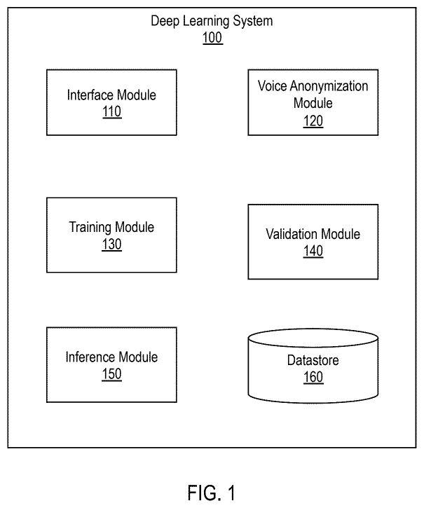

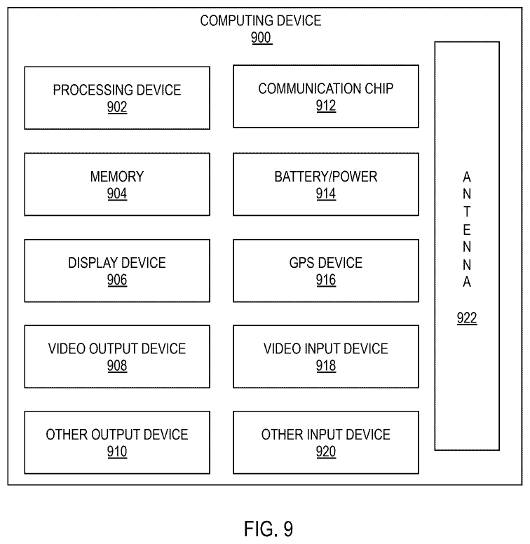

FIG. 1 is a block diagram of an example DNN system 100, in accordance with various embodiments. The DNN system 100 trains DNNs for various tasks, including voice anonymization and deepfake detection. The DNN system 100 includes an interface module 110, a voice anonymization module 120, a training module 130, a validation module 140, an inference module 150, and a datastore 160. In other embodiments, alternative configurations, different or additional components may be included in the DNN system 100. Further, functionality attributed to a component of the DNN system 100 may be accomplished by a different component included in the DNN system 100 or a different system. The DNN system 100 or a component of the DNN system 100 (e.g., the training module 130 or inference module 150) may include the computing device 900 in FIG. 9.

The interface module 110 facilitates communications of the DNN system 100 with other systems. As an example, the interface module 110 supports the DNN system 100 to distribute trained DNNs to other systems, e.g., computing devices configured to apply DNNs to perform tasks. As another example, the interface module 110 establishes communications between the DNN system 100 with an external database to receive data that can be used to train DNNs or input into DNNs to perform tasks. In some embodiments, data received by the interface module 110 may have a data structure, such as a matrix. In some embodiments, data received by the interface module 110 may be an image, a series of images, and/or a video stream.

The voice anonymization module 120 performs voice anonymization in real time. The voice anonymization module 120 can perform voice anonymization in real time on a speaker's computing device. In general, the voice anonymization module 120 receives the input audio data and generates a voice embedding as well as a transformed speaker voice. The transformed speaker voice can sound like a natural voice, but distinctive features of the voice are altered. The voice embedding and transformed speaker voice are transmitted to the listener device, where the original speaker voice can be recovered. In some examples, the speaker may choose to remain anonymous and not share the voice embeddings.

To perform voice anonymization, the voice anonymization module 120 identifies features of the voice to alter or remove from the audio data and embed in a separate voice embedding. In some examples, the voice anonymization module 120 includes both a capture pipeline (to receive the speaker voice, process the speaker voice for anonymization, and transmit the anonymized voice over VIP to a listener computing device) and a render pipeline (to receive an anonymized speaker voice and voice embedding, and reconstruct the original speaker voice). Note that on a single device, the capture pipeline may function on the speaker's voice while the render pipeline may process a received anonymized voice.

The training module 130 trains DNNs by using training datasets. In some embodiments, a training dataset for training a DNN may include one or more audio samples, each of which may be a training sample. In some examples, the training module 130 trains the voice anonymization module 120. The training module 130 may receive real-world audio data for processing with the voice anonymization module 120 as described herein. In some embodiments, the training module 130 may input different data into different layers of the DNN. For every subsequent DNN layer, the input data may be less than the previous DNN layer.

In some embodiments, a part of the training dataset may be used to initially train the DNN, and the rest of the training dataset may be held back as a validation subset used by the validation module 140 to validate performance of a trained DNN. The portion of the training dataset not including the tuning subset and the validation subset may be used to train the DNN.

The training module 130 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 130 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different categories by training.

In the process of defining the architecture of the DNN, the training module 130 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 130 defines the architecture of the DNN, the training module 130 inputs a training dataset into the DNN. The training dataset includes a plurality of training samples. An example of a training dataset includes a series of audio samples from an audio stream. Unlabeled, real-world audio samples are input to the voice anonymization module 120, and processed using the calibration parameters of the DNN to produce model-generated outputs. In some examples, a first model-generated output can be based on a first set of captured audio samples from the voice anonymization system and a second model-generated output can be based on a second set of audio samples from the voice anonymization system. The rendered voice can be compared to the input audio. The internal parameters include weights of filters in the convolutional layers of the DNN. In some embodiments, the training module 130 uses a cost function to minimize the differences. In some examples, the DNN performs feature detection on each of the input audio samples, and the DNN performs pairwise feature matching between/among audio samples in a set (e.g., the first set of audio samples, the second set of audio samples).

The training module 130 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 130 finishes the predetermined number of epochs, the training module 130 may stop updating the parameters in the DNN. The DNN having the updated parameters is referred to as a trained DNN.

The validation module 140 verifies accuracy of trained DNNs. In some embodiments, the validation module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 140 may determine an accuracy score measuring the precision, recall, or a combination of precision and recall of the DNN. The validation module 140 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 140 may compare the accuracy score with a threshold score. In an example where the validation module 140 determines that the accuracy score of the augmented model is lower than the threshold score, the validation module 140 instructs the training module 130 to re-train the DNN. In one embodiment, the training module 130 may iteratively re-train the DNN until the occurrence of a stopping condition, such as the accuracy measurement indication that the DNN may be sufficiently accurate, or a number of training rounds having taken place.

The inference module 150 applies the trained or validated DNN to perform tasks. The inference module 150 may run inference processes of a trained or validated DNN. In some examples, inference makes use of the forward pass to produce model-generated output for unlabeled real-world data. For instance, the inference module 150 may input real-world data into the DNN and receive an output of the DNN. The output of the DNN may provide a solution to the task for which the DNN is trained for.

The inference module 150 may aggregate the outputs of the DNN to generate a final result of the inference process. In some embodiments, the inference module 150 may distribute the DNN to other systems, e.g., computing devices in communication with the DNN system 100, for the other systems to apply the DNN to perform the tasks. The distribution of the DNN may be done through the interface module 110. In some embodiments, the DNN system 100 may be implemented in a server, such as a cloud server, an edge service, and so on. The computing devices may be connected to the DNN system 100 through a network. Examples of the computing devices include edge devices.

The datastore 160 stores data received, generated, used, or otherwise associated with the DNN system 100. For example, the datastore 160 stores video processed by the multi-camera calibration module 120 or used by the training module 130, validation module 140, and the inference module 150. The datastore 160 may also store other data generated by the training module 130 and validation module 140, such as the hyperparameters for training DNNs, internal parameters of trained DNNs (e.g., values of tunable parameters of activation functions, such as Fractional Adaptive Linear Units (FALUs)), etc. In the embodiment of FIG. 1, the datastore 160 is a component of the DNN system 100. In other embodiments, the datastore 160 may be external to the DNN system 100 and communicate with the DNN system 100 through a network.

### Example Voice Anonymization System

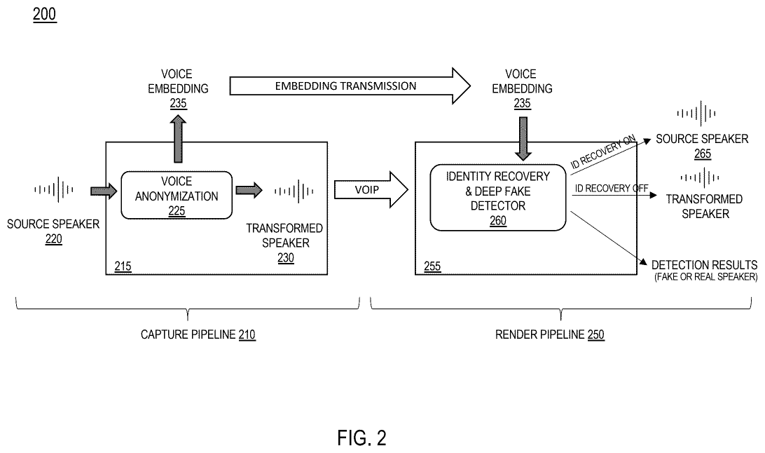

Users often have privacy concerns during VoIP calls and other teleconferences, and voice anonymization can help protect user privacy. FIG. 2 shows an example of a voice anonymization system 200, in accordance with various embodiments. The voice anonymization system 200 includes a capture pipeline 210, configured to receive an audio input including the speaker voice and perform voice anonymization on the received audio input to generate a transformed speaker voice and a voice embedding. The voice anonymization system 200 also includes a render pipeline 250 to receive the transformed speaker voice 230 and perform identity recovery, restoring the original speaker voice received at the capture pipeline 210.

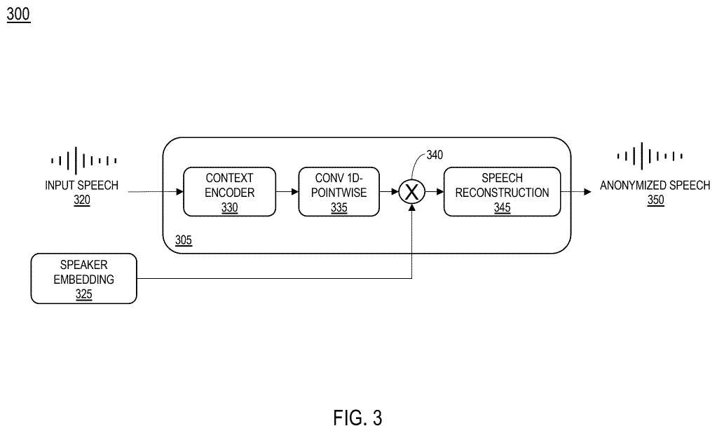

As shown in FIG. 2, the capture pipeline 210 is on a first device 215, where the first device 215 can be a computing device used by a speaker. The capture pipeline 210 receive an audio input including the source speaker voice 220 at a voice anonymization module 225. The voice anonymization module 225 can be a neural network, and the voice anonymization module 225 alters features of the source speaker voice 220 and generates a transformed speaker voice 230. The voice anonymization module 225 also generates a voice embedding 235. The voice embedding 235 includes information that can be used to reconstruct the transformed speaker voice 230, and restore the voice to the original source speaker voice 220. In various examples, the voice embedding 235 is encrypted and transmitted to a receiving device separately from the transformed speaker voice 230. In some examples, the voice embedding 235 is transmitted over a secure channel. The voice anonymization module 225 is described in greater detail with respect to FIGS. 3-6.

The render pipeline 250 is on a second device 255, where the second device 255 can be a computing device used by a receiver, where the receiver is a listener of the speaker. The render pipeline 250 receives an audio input including the transformed speaker voice 230 at an identity recovery module 260. In some examples, the transformed speaker voice 230 is transmitted from the first device 215 to the second device 255 over a VoIP network. The identity recovery module 260 also receives the voice embedding 235. The identity recovery module 260 decrypts the voice embedding 235 and uses the voice embedding 235 information to reconstruct the source speaker voice 220 from the transformed speaker voice 230. The identity recovery module 260 can be a neural network. The identity recovery module 260 recovers features of the source speaker voice 220 from the voice embedding 235 to reconstruct the source speaker voice 220 and output the reconstructed source speaker voice 265. In some examples, identity recovery can be turned on or off by the speaker (i.e., at the first device 215). When identity recovery is turned off, the identity recovery module 260 does not reconstruct the source speaker voice 220 and the output is the transformed speaker voice 230 as received at the identity recovery module 260 on the second device 255. In some examples, when identity recovery is turned off at the first device 215, the voice embedding 235 is not transmitted to the second device 255.

In some examples, the second device 255 does not include an identity recovery module 260, and the transformed speaker voice 230 as received at the second device 255 is the output audio for the listener. In some implementations, the second device 255 includes a deep fake detector that can determine whether the incoming audio is real or transformed. The deep fake detector can inform the user of the second device 255 whether the audio input is real (e.g., the original source speaker voice) or transformed (e.g., the transformed speaker voice 230).

In some examples, the first device 215 and the second device 255 include both a capture pipeline 210 and a render pipeline 250, such that during a conversation or discussion, the voices of speakers at both computing devices 215, 255 can be anonymized before transmission and restored at the other device 215, 255. In some examples, only one of the first device 215 and the second device 255 includes a capture pipeline 210. In some examples, the first device 215 includes both a capture pipeline 210 and a render pipeline 250, and the second device 255 includes only a render pipeline 250.

In various examples, the voice anonymization system 200 is flexible and can be configured in various ways. For instance, one configuration allows the user of the first device 215 to hide their identity by ensuring that the voice embedding 235, which stores distinctive voice features, is not extracted during data transmission, such as on a VoIP server. After anonymization at the voice anonymization module 225, the speech remains intact and transformed speaker voice sounds natural, but the distinctive features of the voice are changed. The voice anonymization system 200 can keep the data related to user identity secure. In some examples, the voice anonymization system 200 is implemented on an edge device (e.g., a PC or personal computer).

FIG. 3 is a diagram 300 illustrating details of a voice anonymization module 305, in accordance with various embodiments. The voice anonymization module 225 can be implemented using the voice anonymization module 305. The voice anonymization module 305 is a convolutional neural network (CNN) and includes a context encoder 330, a 1D pointwise convolution module 335, a multiplier 340, and a speech reconstruction module 345. The input speech 320 is received at the context encoder 330, where it is encoded and then undergoes a 1D pointwise convolution, generating a convolution output. The convolution output is multiplied by a speaker embedding at the multiplier 340 and the output is received at a speech reconstruction module 345, which generates the transformed (anonymized) speech 350 for transmission to a second device. In some examples, the speech reconstruction module generates a speech signal based on a vector that contains speech context and speaker embedding. In various examples, the speech reconstruction module 345 also outputs a voice embedding specific to the input speech 320, and the voice embedding can be encrypted and transmitted over a secure channel to the second device.

In various examples, the voice anonymization module 305 can be implemented using a HuBERT architecture, a HiFI-GAN architecture, and/or any other appropriate neural network architecture. The architecture functions as a causal and low-latency system for real-time audio processing. A HuBERT architecture (Hidden-unit Bidirectional Encoder Representation from Transformers) is a deep learning model that uses offline clustering to generate target labels, masked prediction for prediction loss over masked regions of the input speech, and iterative training. A HiFi-GAN architecture (High-Fidelity Generative Adversarial Network) uses a GAN (Generative Adversarial Network) framework including a generator and for generating audio and discriminators to evaluate the generated audio. In various implementations, the voice anonymization module 305 uses a CNN architecture is adapted to function as a causal and low-latency system by applying causal padding to convolutional layers, enabling real-time audio processing.

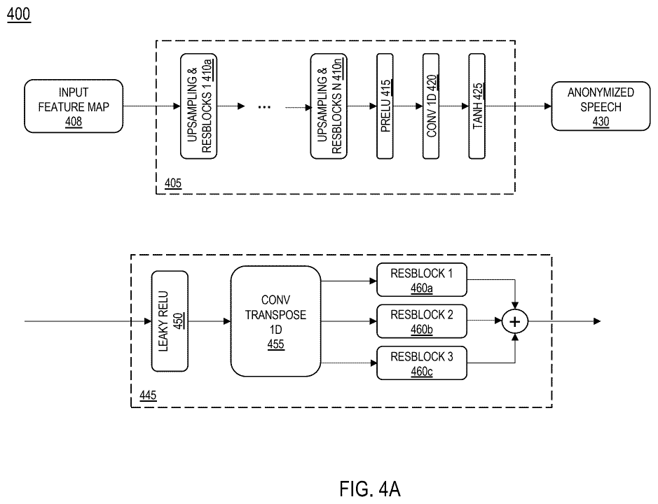

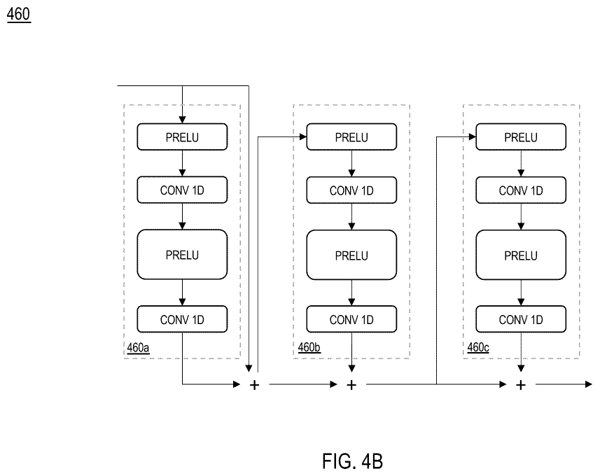

FIGS. 4A-4B illustrate an example architecture 400 for implementing a voice anonymization module 405, in accordance with various embodiments. In particular, voice anonymization module 405 includes multiple upsampling and residual blocks (resblocks 410a-410n), a Parametric Rectified Linear Unit (PReLU) block 415, a 1D convolution block 420, and a hyperbolic tangent (TanH) activation function block 425. In some examples, the module 445 illustrates the architecture of each of the resblocks 410a-410n, which perform upsampling with a residual block. In particular, the module 445 shows an implementation of a the upsampling and residual blocks 410a-410n, including a leaky Rectified Linear Unit (ReLU) 450, a 1D convolution transpose block 455, and resblocks 460a-460c. The output of the resblocks 460a-460c are added an adder to generate the output from the module 445. FIG. 4B illustrates example implementations of resblocks 460a-460c, in which each resblock 460a-460c includes a first PRELU unit, a first 1d convolution unit, a second PRELU unit, and a second 1d convolution unit.

According to various implementations, a voice anonymization module, such as the voice anonymization module 405, uses custom data augmentation and utilizes larger data chunks during training than other systems, which allows for an extended context length for analysis of the input audio. In some examples, the data chunks used during training are about four times larger than data chunks used in other systems. For example, the data chunks can be over 32,000 samples compared to a system that uses data chunks of around 8,000 samples. Having larger data chunks increases system performance due to the increased context length.

According to some implementations, the number of trainable parameters used in the voice anonymization module, such as the voice anonymization module 405, is reduced as compared to other systems. In particular, a voice anonymization module based on a GAN model can be trained using about 1/15 of the parameters used to train other models. For instance, a conventional model uses around 14 million trainable parameters while the voice anonymization module discussed herein uses less than one million trainable parameters (e.g., 0.9 million trainable parameters). The reduction in the number of trainable parameters is achieved, in part, through structural modifications to the neural network, such as through the use of weight sharing between ResBlocks 460a, 460b, 460c, as illustrated in FIGS. 4A-4B. The reduction in the number of trainable parameters both reduces the model size and enables the voice anonymization module to operate on high-quality audio data, such as audio data having a sampling rate of 48 kHz.

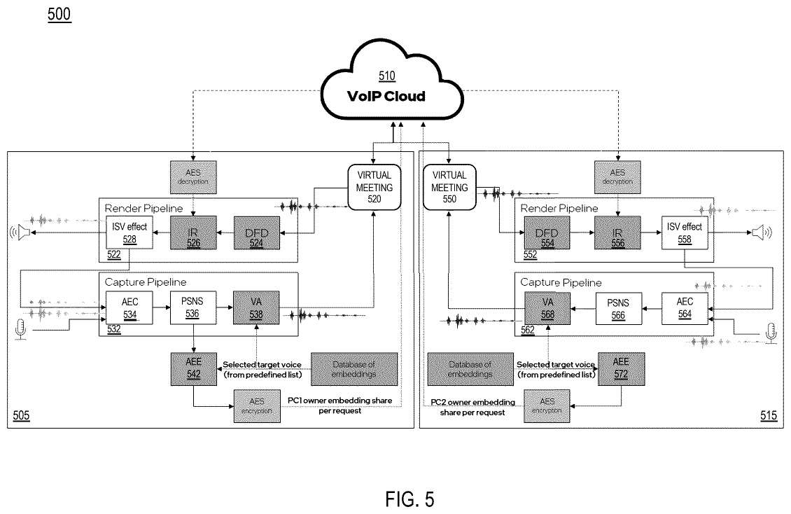

FIG. 5 illustrates a voice anonymization system 500 including two computing devices 505, 515 and a cloud 510, in accordance with various embodiments. The diagram shown in FIG. 5 illustrates two computing devices 505, 515, each having a voice anonymization system including a capture pipeline 532, 562 and a render pipeline 522, 552. The capture pipelines 532, 562 include an acoustic echo cancellation module 534, 564 and a voice anonymization module 538, 568. In some examples, the capture pipelines 532, 562 include a denoising module 536, 566. A voice embedding can be selected from a database of embeddings and used to anonymize the voice at the voice anonymization module 538, 568. An automatic embedding extractor (AEE) 542, 582 receives the selected embedding and selected voice features that are altered and generates a voice embedding file, which is encrypted and transmitted via the cloud 510 to the receiving computing device.

The render pipelines 522, 552 include a Deepfake Detector (DFD) 524, 554 and an Identity Recovery (IR) module 526, 556. In some examples, the render pipelines 522, 552 can include an additional block 528, 558, which can be configured for additional processing of the signal. The render pipelines 522, 552, receive an audio input that can include a transformed voice from the transmitting device. The DFDs 524, 554 identify whether the received audio input includes a transformed voice. When the audio input includes a transformed voice, a decryption module can receive the encrypted voice embedding file from the transmitting device and decrypts the voice embedding. The IR modules 526, 556 receive the transformed voice and the decrypted voice embedding and reconstruct the original speaker voice. In some examples, no voice embedding file is received at the receiving computing device, and the transformed voice is not reconstructed to generate the original speaker voice.

In some examples, various audio processing blocks shown in white are present in a general audio stack. In some examples, the systems include infrastructure elements used to ensure security, such as internet protocols used for encryption.

In FIG. 2, the capture 532, 562 and render 522, 552 pipelines are illustrated as two separate pipelines. However, in some implementations, the capture 532, 562 and render 522, 552 pipelines can be supported on one PC (as shown in FIG. 5). In some examples, implementing both pipelines on a single computing device allows the voices of both participants (speaker and listener) during a VoIP conversation or other teleconference to be simultaneously anonymized and recovered by the pipelines implemented in the participants' computers.

In various examples, the systems and methods discussed herein include various modes of operation. One mode of operation is to use the capture and render pipelines as a working pair. In this mode, both the transmitting computing device and the receiving computing device include the capture 532, 562 and render 522, 552 pipelines. Thus, a first computing device 505 can anonymize the source speaker and send an encrypted embedding of the speaker voice over a secure channel to the second computing device 515, and the second computing device 515 can recover the identity of the source speaker and reconstruct the source speaker voice. Consequently, the listener can hear the source speaker's voice.

Another mode of operation functions when only one computing device in a teleconference is equipped with the voice anonymization system. The processing pipelines in the computing device with the voice anonymization system can run independently of the other computing device. Thus, for example, the capture pipeline 532 in the first computing device 505 can anonymize the source speaker voice for transmission, and the render pipeline 522 can perform voice deepfake detection on received audio files. In various examples, deepfake detection can be a useful feature without the ability to recover the source voice, as it can inform a user whether received audio includes an anonymized voice.

### Example Capture Pipeline

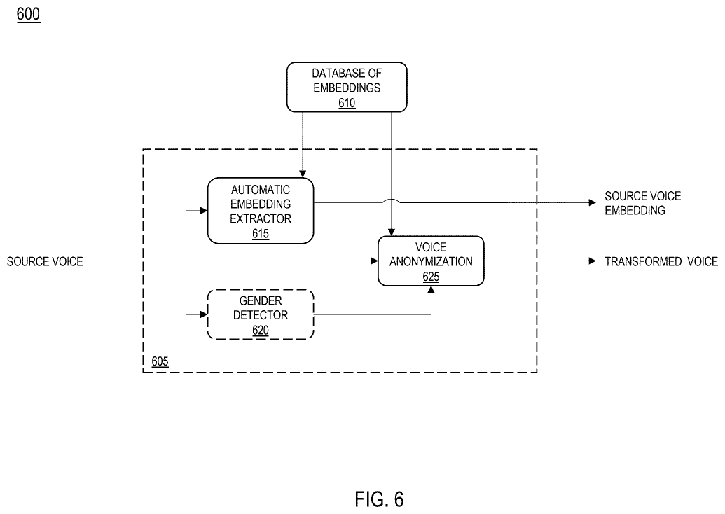

FIG. 6 is a diagram illustrating an example 600 of a capture pipeline 605, in accordance with various embodiments. According to various implementations, the capture pipeline 605 anonymizes the source voice based on predefined embeddings stored in a local database 610. The local database can be a database stored on the computing device that the capture pipeline 605 runs on. The capture pipeline 605 includes a voice anonymization module 625. As discussed above, the voice anonymization module includes neural network, which performs the voice anonymization. The neural network can be a deep generative neural network, and in some examples, the neural network is a One-shot Voice Conversion neural network or a Language Independent Speaker Anonymization neural network. The capture pipeline 605 can also generate the source speaker voice embedding file. In some examples, generation of the voice embedding file can be performed with an Automatic Embedding Extractor (AEE) 615, which generates the speaker embedding iteratively in real time. In some examples, the capture pipeline 605 includes a biological gender detection module 620. The gender detection module 620 can be a neural network. In various examples, gender information can provide additional information to the voice anonymization module 625 and can improve performance of the voice anonymization module.

In various examples, the system of FIG. 6 allows for two methods of anonymization. The first method is a partial transform method and uses a predefined embedding to transform the source voice into a transformed voice that is somewhat similar to the original source voice. In particular, in the partial transform method, the anonymization result (i.e., the transformed voice) may sound somewhat similar to the original source voice. However, algorithms such as the speaker identification detector (SID) are unable to identify the source voice in the transformed voice signal. In the partial transform method, the gender detection module 620 provides additional information about the original source voice to improve the quality of the transformation.

The second method of anonymization is the transformation of the voice into a generic transform method and transforms the source voice into a generic and predefined voice supplied with the computing device. In various examples, there can be more than one predefined voice. The predefined voices can include different types of voices, such as voices that sound like female voices, voices that sound like male voices, and non-gender specific voices. Each generic voice is represented by a different embedding stored in the database of embeddings 610. In some examples, a user can choose which voice to use for voice anonymization. In some examples, the gender detection module 620 can select the transformation embedding if no voice has been selected by a user. In some examples, by default, the system is set to transform a male-identified voice to a voice that sounds like a male voice, and the system is set to transform a female-identified voice to a voice that sounds like a female voice. However, the user can select a different configuration. In some examples, the voice can be transformed by the voice anonymization module 625 to sound like a specific voice, allowing the user to impersonate the selected voice (e.g., a famous person).

In some examples, the user of the computing device can decide to transmit the voice embedding file to potential recipients. If the voice embedding file is transmitted from the computing device, recipients of the voice embedding file and the transformed voice can reconstruct the original source voice. In some examples, the voice embedding file is prepared by the AEE 615 and is encrypted using a cryptographic algorithm (such as, for example, AES-256). The encrypted voice embedding file can be sent to the receiving device via a secure Internet channel. Once the receiving device decrypts the received voice embedding file, the receiving device can use the decrypted voice embedding file to recover the original source voice including identifying characteristics of the original source voice, as described as described herein.

### Example Render Pipeline

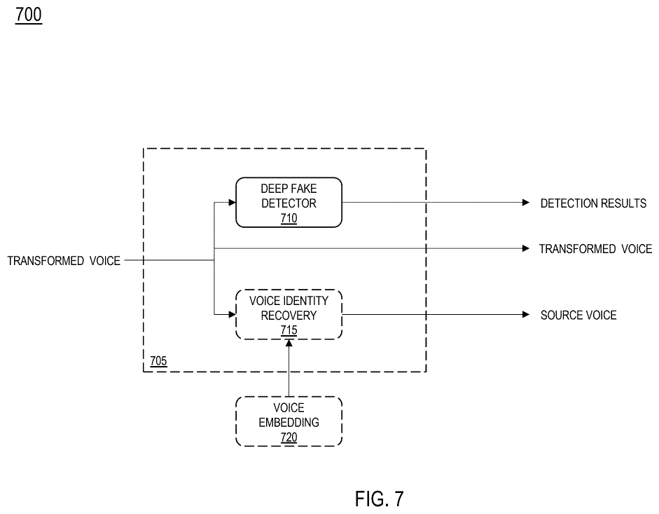

FIG. 7 is a diagram illustrating an example 700 of a render pipeline 705, in accordance with various embodiments. In some examples, the render pipeline 705 can perform two independent functions. A first function is performed at a voice identity recovery module 715, where the original speaker voice is reconstructed based on the transformed voice and a decrypted voice embedding file. A second function is performed at a deep fake detector 710, wherein the render pipeline 705 can detect whether a voice in a received audio input is an original voice or whether a received voice was created is a voice that has been transformed, anonymized, and/or generated (e.g., via a text-to-speech (TTS)). The deepfake detector module 710 can be implemented based on a neural network algorithm, such as an audio deepfake detection algorithm.

In various implementations, the voice identity recovery module 715 transforms the incoming voice back to the original source voice using the voice embedding file 720. In particular, when the voice embedding file 720 is encrypted, the receiving device decrypts the voice embedding file 720 for use. In various examples, the source speaker (and thus the transmitting computing device) determines whether the voice embedding is transmitted to the render pipeline 705 and thus whether the transformed voice can be recovered and reconstructed. The voice identity recovery module 715 can be implemented using a neural network, and in some examples, the implementation of the voice identity recovery module 715 is based on the same neural network as the voice anonymization module, such as the voice anonymization module 625 of FIG. 6. In some examples, the voice identity recovery module 715 and the voice anonymization module 625 can be trained using an encoder-decoder approach.

In various examples, the render pipeline 705 may generate different results depending on the information provided by the transmitting computing device. In some examples, if the user on the transmitting computing device consents and agrees to transmission of the voice embedding file, identity recovery can be performed at the render pipeline 705 using the voice embedding file 720. When the render pipeline 705 receives the voice embedding file 720, the deep fake detector 710 is disabled. However, in some examples, the transmitting device does not transmit the voice embedding file 720 (e.g., a user does not agree to identity recovery, and/or the receiving device is not equipped with a voice identity recovery system), and the received voice remains unchanged. The Deepfake Detector 710 can inform the listener at the second computing device whether the incoming voice is real or transformed.

### Example Method for Voice Anonymization

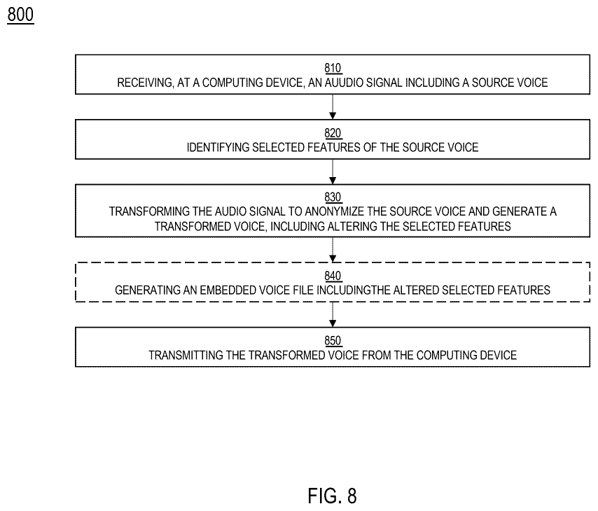

FIG. 8 is a flowchart illustrating a method 800 for voice anonymization, in accordance with various embodiments. The method 800 may be performed by the computing device 900 in FIG. 9. Although the method 800 is described with reference to the flowchart illustrated in FIG. 8, many other methods for voice anonymization may alternatively be used. For example, the order of execution of the steps in FIG. 8 may be changed. As another example, some of the steps may be changed, eliminated, or combined.

At step 810, an audio signal including a source voice is received at a computing device. The computing device can be connected to a teleconference and/or VoIP meeting, and the source voice can be the voice of a user of the computing device, for transmission to the teleconference and/or VoIP meeting. In some examples, the audio signal is received at a capture pipeline of a voice anonymization module as discussed herein.

At step 820, selected features of the source voice are identified. In particular, the selected features can include various characteristics of the source voice that can be used to identify the speaker of the source voice, such as laryngeal tone, timbre, pitch, prosody, and/or other voice and/or speech features. At step 830, the audio signal is transformed at the computing device. In particular, the audio signal is transformed to anonymize the source speaker such that the source speaker cannot be identified by their voice. Transforming the audio signal includes altering one or more of the selected features of the source voice to generate a transformed voice. In some examples, altering one or more of the selected features can include removing the selected feature from the source voice to generate the transformed voice. In some examples, altering one or more of the selected features can include changing a frequency, amplitude, or other characteristic of the selected feature. In various examples, the selected features that are altered anonymize the voice while generating a natural sounding transformed voice that has similar intonation to the source voice.

Optionally, at step 840, an embedded voice file is generated, including the altered selected features. In particular, the embedded voice file includes information regarding changes to the source voice made to generate the transformed voice, such that the embedded voice file can be used to reconstruct the source voice from the transformed voice, restoring the altered features to the original features of the source voice. In some examples, the embedded voice file can be transmitted to another computing device along with the transformed voice, and a render pipeline at the other computing device can be used to reconstruct the source voice. In this manner, the source voice is not transmitted and information transmitted to the teleconference and/or VoIP call is anonymous. The embedded voice file can be encrypted before transmission over a secure channel to the other computer device.

At step 850, the transformed voice is transmitted from the computer device. For example, the transformed voice can be transmitted to another computing device. In some examples, the computing device is part of a teleconference and/or VoIP meeting, and the user of the computing device prefers their voice be anonymized when received at other devices in the meeting. Thus, in various examples, the voice anonymization system discussed herein can be used to transmit a transformed (anonymized) voice. While in some examples, the transformed voice can be reconstructed with a voice embedding as discussed above, in some examples, the transformed voice output from the other devices in the meeting and is not reconstructed.

### Example Computing Device

FIG. 9 is a block diagram of an example computing device 900, in accordance with various embodiments. In some embodiments, the computing device 900 may be used for at least part of the systems in FIGS. 1-7. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable for occupancy mapping or collision detection, e.g., the method 800 described above in conjunction with FIG. 8 or some operations performed by the DNN system 100 in FIG. 1. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 912 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 912 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### SELECT EXAMPLES

Example 1 provides a computer-implemented method for anonymizing a source voice in real time, including receiving an audio signal including the source voice on a computing device; identifying selected features of the source voice to alter for anonymization; transforming, on the computing device, the audio signal to anonymize the source voice and generate a transformed voice in real time, where transforming the audio signal to anonymize the source voice includes altering the selected features; and transmitting the transformed voice from the computing device.

Example 2 provides the computer-implemented method of example 1, where transforming the audio signal includes inputting the audio signal into a convolutional neural network configured to alter the selected features.

Example 3 provides the computer-implemented method of example 1, further including generating an embedded voice file including the altered selected features, where the embedded voice file can be used in conjunction with the transformed voice to restore the source voice.

Example 4 provides the computer-implemented method of example 3, further including transmitting the embedded voice file over a secure channel.

Example 5 provides the computer-implemented method of example 4, further including encrypting the embedded voice file to generate an encrypted embedded voice file, and where transmitting the embedded voice file includes transmitting the encrypted embedded voice file.

Example 6 provides the computer-implemented method of example 1, where the audio signal is a first audio signal, and further including receiving a second audio signal including a second voice at a render pipeline, and determining whether the second voice is an original speaker voice.

Example 7 provides the computer-implemented method of example 6, further including receiving an embedded voice file, and reconstructing the original speaker voice based on the second voice and the embedded voice file.

Example 8 provides one or more non-transitory computer-readable media storing instructions executable to perform operations, the operations including receiving an audio signal including the source voice on a computing device; identifying selected features of the source voice to anonymize; transforming, on the computing device, the audio signal to anonymize the source voice and generate a transformed voice in real time, where transforming the audio signal to anonymize the source voice includes altering the selected features; and transmitting the transformed voice from the computing device.

Example 9 provides the one or more non-transitory computer-readable media of example 8, where transforming the audio signal includes inputting the audio signal into a convolutional neural network configured to alter the selected features.

Example 10 provides the one or more non-transitory computer-readable media of example 8, the operations further including generating an embedded voice file including the altered selected features, where the embedded voice file can be used in conjunction with the transformed voice to restore the source voice.

Example 11 provides the one or more non-transitory computer-readable media of example 10, the operations further including transmitting the embedded voice file over a secure channel.

Example 12 provides the one or more non-transitory computer-readable media of example 11, the operations further including encrypting the embedded voice file to generate an encrypted embedded voice file, and where transmitting the embedded voice file includes transmitting the encrypted embedded voice file.

Example 13 provides the one or more non-transitory computer-readable media of example 8, where the audio signal is a first audio signal, and further including receiving a second audio signal including a second voice at a render pipeline, and determining whether the second voice is an original speaker voice.

Example 14 provides the one or more non-transitory computer-readable media of example 13, further including receiving an embedded voice file, and reconstructing the original speaker voice based on the second voice and the embedded voice file.

Example 15 provides an apparatus, including a computer processor for executing computer program instructions; and a non-transitory computer-readable memory storing computer program instructions executable by the computer processor to perform operations including receiving an audio signal including the source voice on a computing device; identifying selected features of the source voice to anonymize; transforming, on the computing device, the audio signal to anonymize the source voice and generate a transformed voice in real time, where transforming the audio signal to anonymize the source voice includes altering the selected features; and transmitting the transformed voice from the computing device.

Example 16 provides the apparatus of example 15, where transforming the audio signal includes inputting the audio signal into a convolutional neural network configured to alter the selected features.

Example 17 provides the apparatus of example 15, the operations further including generating an embedded voice file including the altered selected features, where the embedded voice file can be used in conjunction with the transformed voice to restore the source voice.

Example 18 provides the apparatus of example 17, the operations further including transmitting the embedded voice file over a secure channel.

Example 19 provides the apparatus of example 18, the operations further including encrypting the embedded voice file to generate an encrypted embedded voice file, and where transmitting the embedded voice file includes transmitting the encrypted embedded voice file.

Example 20 provides the apparatus of example 15, where the audio signal is a first audio signal, and the operations further including receiving a second audio signal including a second voice at a render pipeline, and determining whether the second voice is an original speaker voice.

Example 21 provides the method of examples 1 and/or 2, wherein transforming the audio signal includes, at the convolutional neural network, encoding the audio signal and processing the encoded audio signal using a 1D pointwise convolution to generate a convolution output.

Example 22 provides the method of examples 1 and/or 2 and/or 21, wherein transforming the audio signal includes multiplying the convolution output by a speaker embedding to generate the transformed voice.

Example 23 provides the one or more non-transitory computer-readable media of examples 8 and/or 9, wherein transforming the audio signal includes, at the convolutional neural network, encoding the audio signal and processing the encoded audio signal using a 1D pointwise convolution to generate a convolution output.

Example 24 provides the one or more non-transitory computer-readable media of examples 8 and/or 9 and/or 23, wherein transforming the audio signal includes multiplying the convolution output by a speaker embedding to generate the transformed voice.

Example 25 provides the apparatus of examples 15 and/or 16, wherein transforming the audio signal includes, at the convolutional neural network, encoding the audio signal and processing the encoded audio signal using a 1D pointwise convolution to generate a convolution output.

Example 26 provides the apparatus of examples 15 and/or 16 and/or 25, wherein transforming the audio signal includes multiplying the convolution output by a speaker embedding to generate the transformed voice.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. A computer-implemented method for anonymizing a source voice in real time, comprising:
receiving an audio signal including the source voice on a computing device;
identifying selected features of the source voice to alter for anonymization;
transforming, on the computing device, the audio signal to anonymize the source voice and generate a transformed voice in real time, wherein transforming the audio signal to anonymize the source voice includes altering the selected features; and
transmitting the transformed voice from the computing device.

2. The computer-implemented method of claim 1, wherein transforming the audio signal includes inputting the audio signal into a convolutional neural network configured to alter the selected features.

3. The computer-implemented method of claim 2, wherein transforming the audio signal includes, at the convolutional neural network, encoding the audio signal and processing the encoded audio signal using a 1D pointwise convolution to generate a convolution output.

4. The computer-implemented method of claim 3, wherein transforming the audio signal includes multiplying the convolution output by a speaker embedding to generate the transformed voice.

5. The computer-implemented method of claim 1, further comprising generating an embedded voice file including the altered selected features, wherein the embedded voice file can be used in conjunction with the transformed voice to restore the source voice.

6. The computer-implemented method of claim 5, further comprising transmitting the embedded voice file over a secure channel.

7. The computer-implemented method of claim 6, further comprising encrypting the embedded voice file to generate an encrypted embedded voice file, and wherein transmitting the embedded voice file includes transmitting the encrypted embedded voice file.

8. The computer-implemented method of claim 1, wherein the audio signal is a first audio signal, and further comprising receiving a second audio signal including a second voice at a render pipeline, and determining whether the second voice is an original speaker voice.

9. The computer-implemented method of claim 8, further comprising receiving an embedded voice file, and reconstructing the original speaker voice based on the second voice and the embedded voice file.

10. One or more non-transitory computer-readable media storing instructions executable to perform operations, the operations comprising:
receiving an audio signal including a source voice on a computing device;
identifying selected features of the source voice to anonymize;
transforming, on the computing device, the audio signal to anonymize the source voice and generate a transformed voice in real time, wherein transforming the audio signal to anonymize the source voice includes altering the selected features; and
transmitting the transformed voice from the computing device.

11. The one or more non-transitory computer-readable media of claim 10, wherein transforming the audio signal includes inputting the audio signal into a convolutional neural network configured to alter the selected features.

12. The one or more non-transitory computer-readable media of claim 11, wherein transforming the audio signal includes, at the convolutional neural network, encoding the audio signal and processing the encoded audio signal using a 1D pointwise convolution to generate a convolution output.

13. The one or more non-transitory computer-readable media of claim 12, wherein transforming the audio signal includes multiplying the convolution output by a speaker embedding to generate the transformed voice.

14. The one or more non-transitory computer-readable media of claim 10, the operations further comprising generating an embedded voice file including the altered selected features, wherein the embedded voice file can be used in conjunction with the transformed voice to restore the source voice.

15. The one or more non-transitory computer-readable media of claim 14, the operations further comprising transmitting the embedded voice file over a secure channel.

16. The one or more non-transitory computer-readable media of claim 8, wherein the audio signal is a first audio signal, and further comprising receiving a second audio signal including a second voice at a render pipeline, and determining whether the second voice is an original speaker voice.

17. An apparatus, comprising:
a computer processor for executing computer program instructions; and
a non-transitory computer-readable memory storing computer program instructions executable by the computer processor to perform operations comprising:
receiving an audio signal including a source voice on a computing device;
identifying selected features of the source voice to anonymize;
transforming, on the computing device, the audio signal to anonymize the source voice and generate a transformed voice in real time, wherein transforming the audio signal to anonymize the source voice includes altering the selected features; and
transmitting the transformed voice from the computing device.

18. The apparatus of claim 17, wherein transforming the audio signal includes inputting the audio signal into a convolutional neural network configured to alter the selected features.

19. The apparatus of claim 18, wherein transforming the audio signal includes, at the convolutional neural network, encoding the audio signal and processing the encoded audio signal using a 1D pointwise convolution to generate a convolution output.

20. The apparatus of claim 19, wherein transforming the audio signal includes multiplying the convolution output by a speaker embedding to generate the transformed voice.
